(19) United States
(12) Patent Application Publication
(10) Pub. No.: US 2023/0306257 A1
(43) Pub. Date: Sep. 28, 2023

(54) SYSTEMS AND METHODS FOR NEURAL NETWORK TRAINING WITH WEIGHT SPARSITY

(71) Applicant: Alibaba (China) Co., Ltd., Hangzhou (CN)

(72) Inventors: Fei SUN, San Jose, CA (US); Minghai QIN, Fremont, CA (US); Haoran LI, Shanghai (CN); Guocai ZHU, Sunnyvale, CA (US); Yuan GAO, Shanghai (CN); Guyue HUANG, Shanghai (CN); Yawen ZHANG, Beijing (CN)

(21) Appl. No.: 17/866,194

(22) Filed: Jul. 15, 2022

(30) Foreign Application Priority Data
Mar. 22, 2022 (CN) 202210289171.5

(51) Int. Cl. G06N 3/08; G06F 7/78; G06F 7/523

(52) U.S. Cl. CPC G06N 3/08; G06F 7/78; G06F 7/523

(57) ABSTRACT

Neural network (NN) model training techniques can include computing activations in a forward pass using a sparse weight matrix that is transpose invariant. The neural network (NN) model training techniques can further include computing activation gradients and weight gradients in a backward pass using the sparse weight matrix.

### CROSS-REFERENCE TO RELATED APPLICATIONS

This application claims priority to Chinese Patent Application No. 202210289171.5 filed Mar. 22, 2022.

### BACKGROUND OF THE INVENTION

In artificial intelligence, artificial neural networks (ANN), also commonly referred to as neural networks (NN), can enable machines to learn. Through practical application of various mathematical functions, neural network models can learn various relationships from datasets thereby improving the performance of computers as compared to conventional software routines. For example, neural networks can learn a mapping function from inputs to outputs by updating weights of a model of the neural network in response to errors generated by the model on a training dataset. Updates are repeatedly made to reduce the error until the model achieves a desired level of generalizing performance. Thereafter, the neural network can be utilized to infer an output from an input.

Referring now to FIG. 1A, a method of training a neural network according to the conventional art is shown. The method can include inputting a training data set to a neural network model to generate an output in a forward pass. The output is compared to a target. The difference between the output and the target can be utilized in a backward pass to adjust the weights of the neural network model. The process of training the neural network model is iteratively repeated until a desired accuracy of the output relative to the target is achieved. Thereafter, the trained neural network model can be used to infer an output from an input, as illustrated in FIG. 1B.

In a number of applications, the size of neural network (NN) models and the time that it takes to train neural network (NN) models continue to increase. Therefore, there is a continuing need for improved systems and methods for training neural network (NN) models.

### SUMMARY OF THE INVENTION

The present technology may best be understood by referring to the following description and accompanying drawings that are used to illustrate embodiments of the present technology directed toward systems and methods for training a neural network (NN) model.

In one embodiment, a method of training a neural network model can include computing activation in a forward pass by a sparse matrix-matrix multiplication (spMM) module using a sparse weight matrix that is transpose invariant. The method can also include computing activation gradients in a backward pass by the sparse matrix-matrix multiplication (spMM) module using a transpose of the sparse weight matrix received from a weight transpose module. The method can further include computing weight gradients, of the neural network (NN) model, in a backward pass by a sampled dense-dense matrix multiplication (SDDMM) module using the activations received from the forward pass of the sparse matrix-matrix multiplication (spMM) module. Computing the activations in the forward pass can further include computing the activations for a current layer, by sparse matrix-matrix multiplication (spMM), based on activations of a previous layer, sparse weight data of the sparse weight matrix of the current layer and sparse weight indices of the sparse weight matrix of the current layer in response to input datasets. Computing the activation gradients in the backward pass can further include computing activation gradients for the previous layer, by the sparse matrix-matrix multiplication (spMM), based on a transpose of the sparse weight indices of the current layer, a transpose of the sparse weight data of the current layer, and activation gradients of the current layer. Computing the weight gradients in the backward pass can further include computing weight gradients of the current layer, by sampled dense-dense matrix multiplication (SDDMM), based on activations of the previous layer, the sparse weight indices of the current layer and the activation gradients of the current layer.

In one embodiment, a system for neural network (NN) model training can include a multiplication module, a weight data transpose module, a weight indices transpose module and a weight update module. The multiplication module can include one or more sparse matrix-matrix multiplication (spMM) modules and one or more sampled dense-dense matrix multiplication (SDDMM) modules. The one or more sparse matrix-matrix multiplication (spMM) modules can be configured to compute activations for a current layer based on activations of a previous layer, the sparse weight data for the current layer, and the sparse weight indices for the current layer in forward propagation of current batch datasets, and compute activation gradients for a previous layer based on the transposed sparse weight data, the transposed sparse weight indices and activation gradients of the current layer in back propagation. The one or more sampled dense-dense matrix multiplication (SDDMM) modules can be configured to compute weight gradients of the current layer based on the activation gradients of the current layer, sparse weight indices of the current layer and the activations of the previous layer in the back propagation. The weight updated module can be configured to compute new sparse weights based on sparse weight data for the current layer and the weight gradients for the current layer.

In one embodiment, a method of training a neural network model can include computing activation in a forward pass using a sparse weight matrix that is transpose invariant. The method can further include computing activation gradients and weight gradients in a backward pass using the sparse weight matrix. Computing the activations in the forward pass can include computing the activations for a current layer, by sparse matrix-matrix multiplication (spMM), based on activations of a previous layer, sparse weight data of the sparse weight matrix of the current layer and sparse weight indices of the sparse weight matrix of the current layer in response to input datasets. Computing the activation gradients in the backward pass can include computing activation gradients for the previous layer, by the sparse matrix-matrix multiplication (spMM), based on a transpose of the sparse weight indices of the current layer, a transpose of the sparse weight data of the current layer, and activation gradients of the current layer. Computing the weight gradients in the backward pass can include computing weight gradients of the current layer, by sampled dense-dense matrix multiplication (SDDMM), based on activations of the previous layer, the sparse weight indices of the current layer and the activation gradients of the current layer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1A illustrates a method of training a neural network according to the conventional art.

FIG. 1B illustrates a method of inferring using a trained neural network according to the conventional art.

FIG. 2 shows a neural network (NN) training system, in accordance with aspects of the present technology.

FIG. 3A illustrates an exemplary transpose invariant sparse weight matrix.

FIG. 3B illustrates an exemplary transpose variant sparse weight matrix.

FIG. 4 shows a system for training a neural network (NN) model, in accordance with aspects of the present technology.

FIG. 5 shows a method of neural network training, in accordance with aspects of the present technology.

FIG. 6 shows a method of neural network training, in accordance with aspects of the present technology.

FIG. 7 shows a method of neural network training, in accordance with aspects of the present technology.

FIG. 8 shows a block diagram of an exemplary processing unit including for implementing embodiments of a neural network (NN) model training, in accordance with aspects of the present technology.

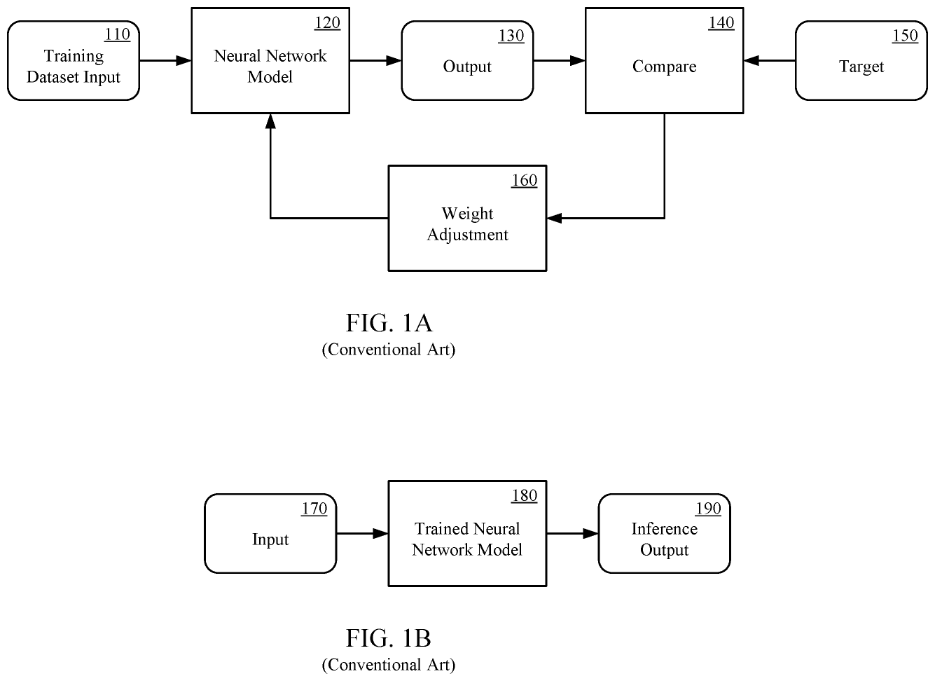

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the technology to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. The use of the terms “comprises,” “comprising,” “includes,” “including” and the like specify the presence of stated elements, but do not preclude the presence or addition of one or more other elements and or groups thereof. It is also to be understood that although the terms first, second, etc. may be used herein to describe various elements, such elements should not be limited by these terms. These terms are used herein to distinguish one element from another. For example, a first element could be termed a second element, and similarly a second element could be termed a first element, without departing from the scope of embodiments. It is also to be understood that when an element is referred to as being “coupled” to another element, it may be directly or indirectly connected to the other element, or an intervening element may be present. In contrast, when an element is referred to as being “directly connected” to another element, there are not intervening elements present. It is also to be understood that the term “and or” includes any and all combinations of one or more of the associated elements. It is also to be understood that the phraseology and terminology used herein is for the purpose of description and should not be regarded as limiting.

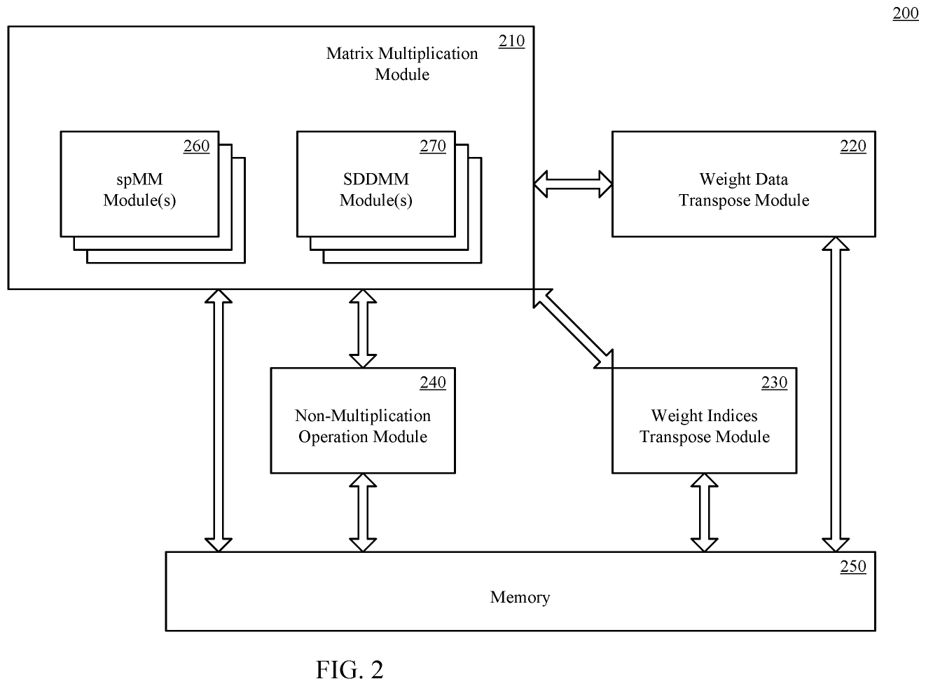

Referring to FIG. 2, a neural network (NN) training system, in accordance with aspects of the present technology, is shown. The NN training system 200 can include a matrix multiplication module 210, a weight data transpose module 220, a weight indices transpose module 230, a non-multiplication module 240, and memory 250. The matrix multiplication module 210 can include one or more sparse matrix-matrix multiplication (spMM) modules 260, and one or more sampled dense-dense matrix multiplication (SDDMM) modules 270. In one implementation, the matrix multiplication module 210 can be configured to compute sparse matrix-matrix multiplication (spMM) in accordance with Equation 1:

C=A×B

wherein A and B are matrices. Each row, i, of C can be computed in accordance with Equation 2:

Cᵢ=Σ_{k∈A}_{ᵢ}A_{i,k}×Bₖ

In one implementation, the matrix multiplication module 210 can be configured to compute sampled dense-dense matrix multiplication (SDDMM) in accordance with Equation 3:

F(D_{*S}E^{T})oS

where D_{∈} [symbol] and E_{∈} [symbol] are dense matrices and S_{∈} [symbol] is the sampling sparse matrix. The modules can be implemented in software, firmware, hardware or any combination thereof. In one implementation, the modules can be implemented as computing device executable instructions (e.g., software) that are stored in computing device readable media (e.g., computer memory) and executed by one or more computing devices (e.g., processing units. In an exemplary implementation, sparse matrix-matrix multiplication (spMM) can be performed by the computing device executable instructions:

```
for (i = 0; i < M; i++) {
  for (j = 0; j < N; j++) {
    C[i, j] = 0;
    for (k =0; k < K; k++) {
      if (M[i,k] != 0) {
        C[i,j] = C[i,j] + A[i,k] * B[k, j];
      }
    }
  }
}
```

In an exemplary implementation, sampled dense-dense matrix multiplication (SDDMM) can be performed by the computing device executable instructions:

```
for (i = 0; i < M; i++) {
  for (j = 0; j < N; j++) {
    if (M[i, j] != 0) {
      for (k =0; k < K; k++) {
        C[i,j] = C[i,j] + A[i,k] * B[k, j];
      }
    }
  }
}
```

The one or more sparse matrix-matrix multiplication (spMM) modules 260 can be configured to compute activations in a forward pass using a sparse weight matrix that is transpose invariant during training a neural network (NN) model. The one or more sparse matrix-matrix multiplication (spMM) modules 260 can also be configured to compute activation gradients using the sparse weight matrix in a backward pass during training of the neural network (NN) model. The one or more sampled dense-dense matrix multiplication (SDDMM) modules 270 can be configured to compute weight gradients using the sparse weight matrix in the backward pass during training of the neural network (NN) model.

A sparse matrix is a matrix in which a substantial number of the element values are zero. A dense matrix is generally considered to be a matrix in which most of the element values are non-zero. The sparsity of a matrix is generally considered to be the ratio of the number of zero-valued elements to the total number of elements of the matrix. For example, if half the values of a matrix are zero values and half are non-zero values, the sparsity of the matrix is 50%. For a sparse matrix, the amount of memory for storage can be reduced by only storing the non-zero element values. The compressed format for a sparse matrix can also reduce computational workload by eliminating computations involving zero value matrix elements. There are a number of data structures used for storing sparse matrices in a condensed format, including but not limited to, dictionary of keys, list of lists, coordinate list, compressed sparse row (CSR), compressed sparse column (CSC), and the like. The CSR data structure represents a sparse matrix with three arrays: a row pointer array, a column indices array and a value array. The value array includes the non-zero values. The column indices array indicates the column in which the non-zero values are located in a given row. The row pointer array indicates where non-zero values for the corresponding row start in the value array. Similarly, a CSC data structure can represent a sparse matrix with a column pointer array, a row indices array and value array. Generally, compressed format matrix data structures, such as CSR and CSC, reduce the amount of storage consumed by the matrix. The compressed format matrix data structures, such as CSR or CSC, can also reduce the computational workload by eliminating computations involving zero value matrix elements.

The transpose of a matrix is an operator which flips a matrix over its diagonal. When transposing a matrix, the rows and columns are switched, which can be performed by switching the row and column indices of the matrix. In an exemplary implementation, the transpose of the matrix can be performed by the computing device executable instructions:

```
for (i = 0; i < M; i++) {
  for (j = 0; j < N; j++) {
    T[i, j] = A[j, i];
  }
}
```

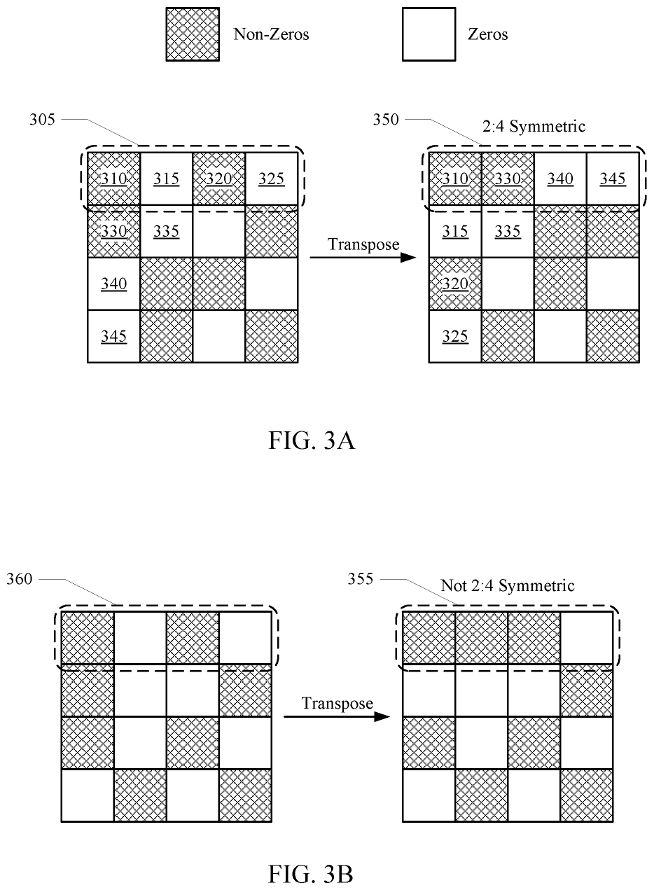

Referring now to FIG. 3A, an exemplary transpose invariant sparse weight matrix and its transpose, in accordance with aspects of the present technology, is illustrated. For example, a four-by-four matrix can be a 50% sparsity weight matrix with two elements in each row 305 being non-zero values 310 320 and two elements in the same row being zero values 315, 325. The four-by-four matrix can be a transpose invariant 50% sparsity matrix when the rows 350 of the transposed matrix also include two non-zero values 310, 330 and two zero values 340, 345. When one or more rows 355 of a transposed four-by-four matrix are not 50% sparse, the sparse matrix is not transpose invariant as illustrated in FIG. 3B. For example, if the original matrix is a 50% sparse matrix with two non-zero elements for every four elements in a selected row 360, one or more rows of the transpose variant matrix can include more or less than two non-zero elements for every four elements in the corresponding row 355.

Although FIGS. 3A and 3B illustrate four-by-four matrixes for ease of explanation, it is appreciated that much larger matrixes are typically used in neural network (NN) processing. Furthermore, it is appreciated that the large matrixes may be divided into windows, tiles, sections or the like for ease of processing. For example, a plurality of four-by-four element windows of a matrix can be dispatch for processing by respective threads of a software based neural network (NN) processor, or dispatch to respective hardware accelerators of a neural network (NN) processor.

Referring again to FIG. 2, the one or more sparse matrix-matrix multiplication (spMM) modules 260 of the matrix multiplication module 210 can compute activations of a current layer based on activations of a previous layer, weight data of the sparse weight matrix of the current layer, and weight indices of the sparse weight matrix of the current layer. The one or more sparse matrix-matrix multiplication (spMM) modules 260 can compute the activations of the current layer in a forward pass in response to a training dataset input. The weight indices transpose module 230 can be configured to transpose the sparse weight indices of the current layer. Similarly, the weight data transpose module 220 can be configured to transpose the sparse weight data of the current layer. In a reverse pass, the one or more sparse matrix-matrix multiplication (spMM) modules 260 can compute activation gradients of the previous layer based on the transposed sparse weight indices of the current layer, the transposed sparse weight data of the current layer, and activation gradients of the current layer. In the reverse pass, the one or more sampled dense-dense matrix multiplication (SDDMM) modules 270 of the matrix multiplication module 210 can compute weight gradients of the current layer based on activations of the previous layer, sparse weight indices of the current layer and the activation gradients of the current layer.

The sparse matrix-matrix multiplication (spMM) modules 260, the sampled dense-dense matrix multiplication (SDDMM) modules 270, the weight data transpose module 220 and weight indices transpose module 230 can iteratively perform the above-described functions for each of a plurality of training datasets. In addition, the non-multiplication operation module 240 can be configured to provide non-multiplication operation support to the sparse matrix-matrix multiplication (spMM) modules 230, the sampled dense-dense matrix multiplication (SDDMM) modules 270, the weight data transpose module 220 and weight indices transpose module 230. In one implementation, the non-multiplication operation module 240 can add the weight gradients for the current layer and the sparse weight data for the current layer together to generate sparse weight data for a next iteration. In an exemplary implementation, the addition of the weight gradients for the current layer and the sparse weight data for the current layer can be performed by the computing device executable instructions:

```
for (i = 0; i < M; i++) {
  for (j = 0; j < N; j++) {
    W[i, j] = W[i, j] + grad[i,j];
  }
}
```

Furthermore, the memory 250 can store training datasets, activations, activation gradients, sparse weight matrixes, weight indices, weight data, transposed weight matrixes, transposed weight indices, transposed weight data, weight gradients and the like for use by the sparse matrix-matrix multiplication (spMM) modules 260, the sampled dense-dense matrix multiplication (SDDMM) modules 270, the weight data transpose module 220, weight indices transpose module 230, and or non-multiplication operations module 240. Although illustrated as a single block, the memory 250 can include one or more types of memory arranged in one or more hierarchical layers. Furthermore, although the sparse matrix-matrix multiplication (spMM) modules 260 and the sampled dense-dense matrix multiplication (SDDMM) modules 270 are illustrated as separate modules, it is appreciated that the sparse matrix-matrix multiplication (spMM) modules 260 can be a subset of the sampled dense-dense matrix multiplication (SDDMM) modules 270. For example, sampled dense-dense matrix multiplication modules shares the majority of the function of the sparse matrix-matrix multiplication (spMM) modules 260 and therefore can be integrated therein.

It should be appreciated that computing the activations in the forward pass is typically performed first for each of the plurality of layers of a neural network (NN) model. Computing the activation gradients and weight gradients in the reverse pass can then be performed for each of the plurality of layers of the neural network (NN) model for a training dataset.

The use of a transpose invariant sparse weight matrix advantageously eliminates redundant calculation by the sparse matrix-matrix multiplication (spMM) modules 260 and the sampled dense-dense matrix multiplication (SDDMM) modules 270. Because the zero value elements do not participate in the computation within the sparse matrix-matrix multiplication (spMM) modules 260 and the sampled dense-dense matrix multiplication (SDDMM) modules 270, the computation of the sparse matrix-matrix multiplication (spMM) modules 260 and the sampled dense-dense matrix multiplication (SDDMM) modules 270 can be completed faster. Therefore, the training time can be decreased, or larger models can be trained within the same amount of time. The sparse weight matrix also advantageously utilizes less memory 250 as compared to dense weight matrixes. In addition, the sparse weight matrix can also be advantageously stored in a compressed format. Furthermore, the transpose of the weight indices can be performed directly on the weight indices stored in the compressed format.

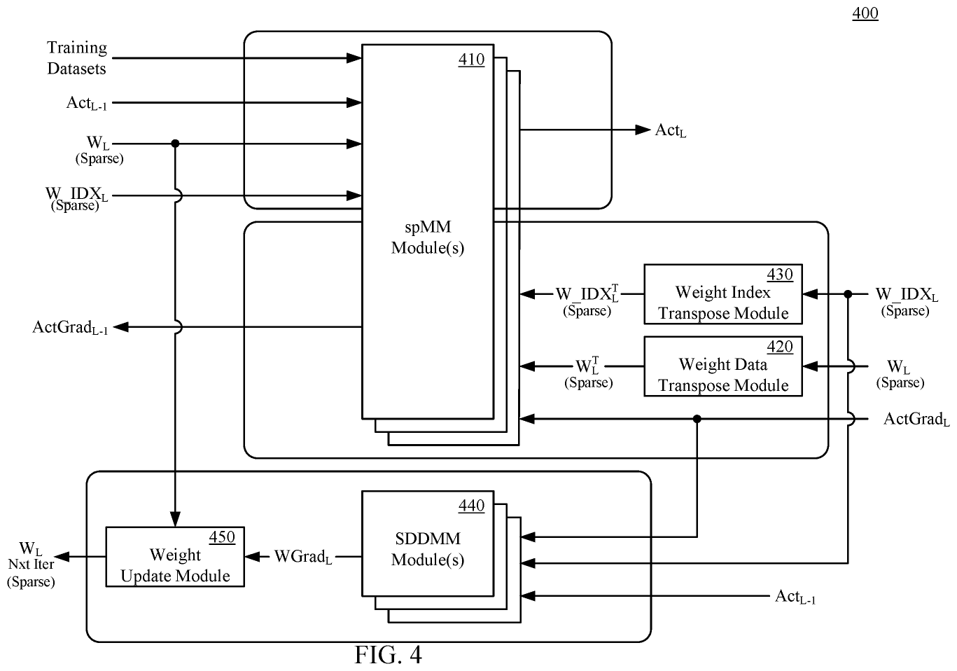

Referring now to FIG. 4, a system for training a neural network (NN) model, in accordance with aspects of the present technology, is shown. The system 400 can include one or more sparse matrix-matrix multiplication (spMM) modules 410 configured to receive training datasets, activations for the previous layer (Act_{L-1}), sparse weight data for the current layer (W_{L}), and sparse weight indices for the current layer (W_IDX_{L}). The one or more sparse matrix-matrix multiplication (spMM) modules 410 can generate activations for the current layer (Act_{L}) in a forward pass as a function of the activations for the previous layer (Act_{L-1}), sparse weight data for the current layer W_{L} and sparse weight indices for the current layer (W_IDX_{L}).

The system 400 can also include a weight data transpose mode 420 to generate transposed sparse weight data for the current layer (W_{L}^{T}) from the sparse weight data for the current layer (W_{L}). The system can also include weight indices transpose module 430 to generate transposed sparse weight indices for the current layer (W_IDX_{L}^{T}) from the sparse weight indices for the current layer (W_IDX_{L}). The one or more sparse matrix-matrix multiplication (spMM) modules 410 can generate activation gradient for the previous layer (ActGrad_{L-1}) in a backward pass as a function of the activation gradient for the current layer (ActGrad_{L}), transposed sparse weight data for the current layer (W_{L}^{T}), and the transposed sparse weight indices for the current layer (W_IDX_{L}^{T}).

The system 400 can also include one or more sampled dense-dense matrix multiplication (SDDMM) modules 440 configured to receive the activations for the previous layer (Act_{L-1}), the activation gradient for the previous layer (ActGrad_{L-1}), and the sparse weight indices for the current layer (W_IDX_{L}). The one or more sampled dense-dense matrix multiplication (SDDMM) modules 440 can generate weight gradients for the current layer (WGrad_{L}) in the backward pass as a function of the activations for the previous layer (Act_{L-1}), the activation gradient for the previous layer (ActGrad_{L-1}), and the sparse weight indices for the current layer (W_IDX_{L}). A weight update module 450 of the system can generate sparse weight data for a next iteration (W_{L Nxt Iter}) in the backward pass as a function of the weight gradients for the current layer (WGrad_{L}) and the sparse weight data for the current layer (W_{L}).

The modules can be implemented in software, firmware, hardware or any combination thereof. In one implementation, the modules can be implemented as computing device executable instructions (e.g., software) that are stored in computing device readable media (e.g., computer memory) and executed by one or more computing devices (e.g., processing units).

Again, it should be appreciated that computing the activations in the forward pass is typically performed first for each of the plurality of layers of a neural network (NN) model. Computing the activation gradients and weight gradients in the reverse pass can then be performed for each of the plurality of layers of the neural network (NN) model for a training dataset.

Again, the system 400 advantageously eliminates redundant calculation by the sparse matrix-matrix multiplication (spMM) modules 410 and the sampled dense-dense matrix multiplication (SDDMM) modules 420. In addition, the functions of the sparse matrix-matrix multiplication (spMM) modules 410 can be reused in the sampled dense-dense matrix multiplication (SDDMM) modules 420. Furthermore, the transpose of the weight indices can be performed directly on the weight indices stored in a compressed format.

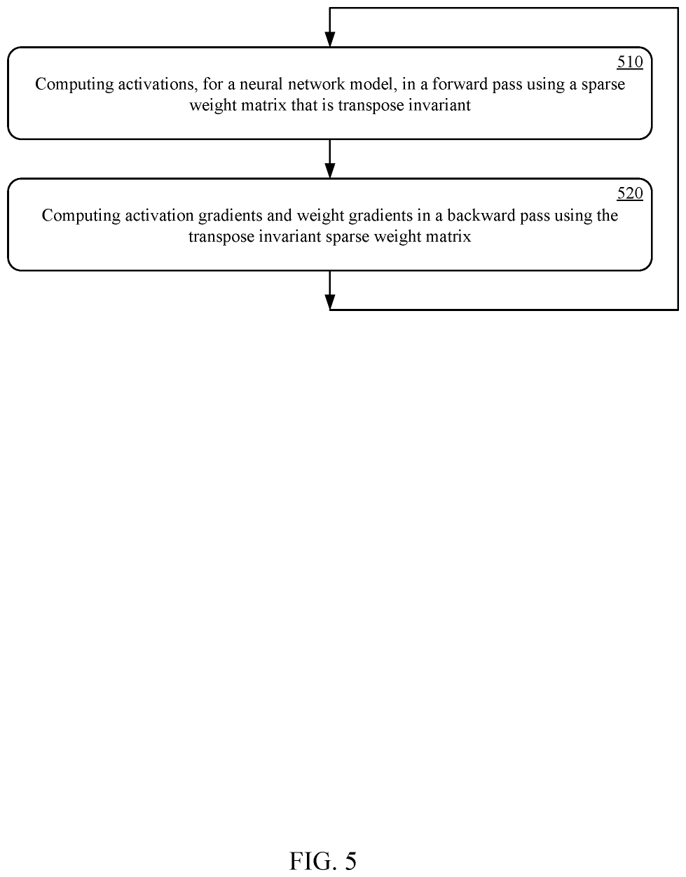

Referring now to FIG. 5, a method of neural network training, in accordance with aspects of the present technology, is shown. The method can be implemented in software, firmware, hardware or any combination thereof. In one implementation, the method can be implemented as computing device executable instructions (e.g., software) that are stored in computing device readable media (e.g., computer memory) and executed by one or more computing devices (e.g., processing units). The method of training the neural network model can include computing activations using a sparse weight matrix that is transpose invariant, at 510. In one implementation, a sparse matrix-matrix multiplication (spMM) can be performed in a forward pass on a batch dataset using a transpose invariant sparse weight matrix for a current layer and activations of a previous layer to compute activations for the current layer. In one implementation, the sparse weight matrix can include the weight data in a compressed format and separate weight indices that refer to the dense activations. By using a transpose invariant sparse matrix, zero value elements do not participate in the computation thereby eliminating redundant computation. The model can be trained with non-zero computations using the transpose invariant sparse weight matrix. Furthermore, because the non-zero weight values are only a fraction of the size of a corresponding dense weight matrix, memory consumption can also be reduced.

At 520, activation gradients and weight gradients can be computed using the sparse weight matrix. In one implementation, a sparse matrix-matrix multiplication (spMM) can be performed in a backward pass on the transpose of the weight matrix for the current layer and activation gradients of the current layer to compute the activation gradient for the previous layer. In addition, a sampled dense-dense matrix multiplication (SDDMM) can be performed on the transpose of the indices of the weight matrix of the current layer, the activations of the previous layer and the activation gradients of the previous layer to compute weight gradients of the current layer. The weight matrix and weight gradient of the current layer can be used to compute the weight matrix for a next iteration. Computation of the activation and the activation gradient can advantageously use sparse matrix-matrix multiplication (spMM).

Again, it should be appreciated that computing the activations in the forward pass at 510 is typically performed first for each of the plurality of layers of a neural network (NN) model. Computing the activation gradients and weight gradients in the reverse pass at 520 can then be performed for each of the plurality of layers of the neural network (NN) model for a training dataset.

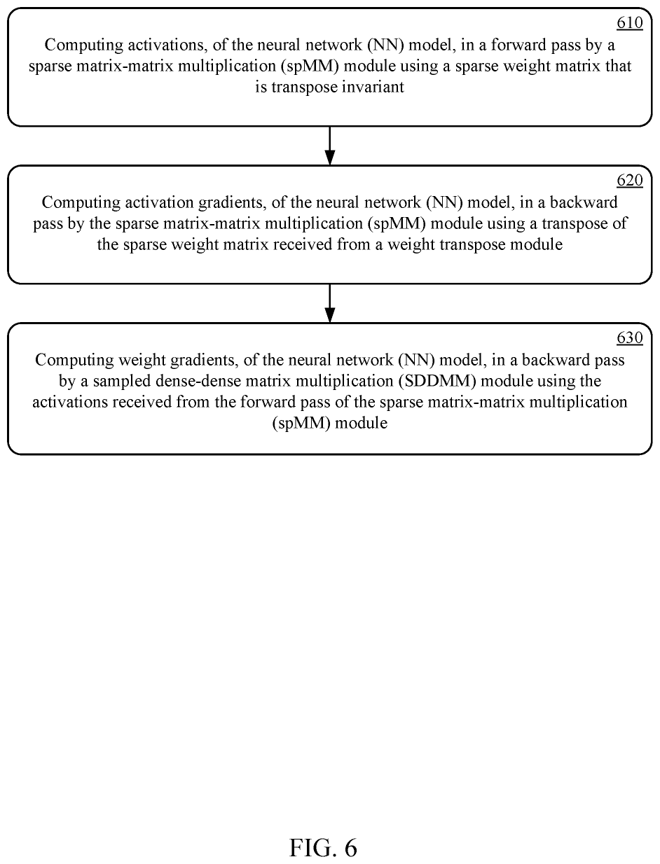

Referring now to FIG. 6, a method of neural network training, in accordance with aspects of the present technology, is shown. The method can be implemented in software, firmware, hardware or any combination thereof. In one implementation, the method can be implemented as computing device executable instructions (e.g., software) that are stored in computing device readable media (e.g., computer memory) and executed by one or more computing devices (e.g., processing units). The method of training the neural network model can include computing activations in a forward pass by a sparse matrix-matrix multiplication (spMM) module using a sparse weight matrix that is transpose invariant, at 610. In one implementation, the activations can be computed by the sparse matrix-matrix multiplication (spMM) module using a sparse weight matrix in a compressed format to reduce computations because the compressed format does not include zero values. Sparse matrix-matrix multiplication can be performed by the sparse matrix-matrix multiplication (spMM) module as described above.

At 620, activation gradients, of the neural network (NN) model, can be computed in a backward pass by the sparse matrix-matrix multiplication (spMM) module using a transpose of the sparse weight matrix received from a weight transpose module. In one implementation, the activation gradients can also be computed by the sparse matrix-matrix multiplication (spMM) module using the compressed sparse weight matrix to reduce computations because the compressed format does not include zero values. The sparsity, compression and transpose of the weight matrix can be performed as described above.

At 630, weight gradients, of the neural network (NN) model, can be computed in a backward pass by a sampled dense-dense matrix multiplication (SDDMM) module using the activations received from the forward pass of the sparse matrix-matrix multiplication (spMM) module. Sampled dense-dense matrix multiplication (SDDMM) can be performed by the sampled dense-dense matrix multiplication (SDDMM) module as described above.

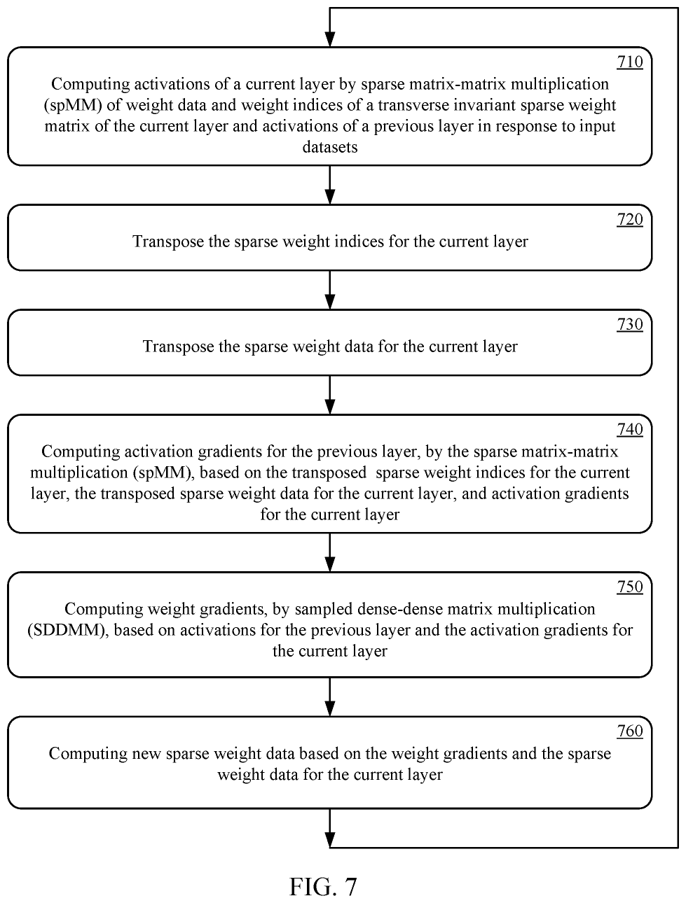

Referring now to FIG. 7, a method of neural network training, in accordance with aspects of the present technology, is shown. The method can be implemented in software, firmware, hardware or any combination thereof. In one implementation, the method can be implemented as computing device executable instructions (e.g., software) that are stored in computing device readable media (e.g., computer memory) and executed by one or more computing devices (e.g., processing units). The method of training the neural network model can include computing activations for a current layer by sparse matrix-matrix multiplication (spMM) of weight values of a transpose invariant sparse weight matrix of the current layer, the indices of the transpose invariant sparse weight matrix of the current layer, and activations of a previous layer in response to an input dataset, at 710. Sparse matrix-matrix multiplication can be performed as described above.

At 720, the sparse weight data for the current layer can be transposed to generate transposed sparse weight data for the current layer. At 730, the sparse weight indices for the current layer can be transposed to generate transposed sparse weight indices. It is appreciated that because the sparse weight matrix is transpose invariant, the sparse weight indices is also transpose invariant. Furthermore, the sparse weight data can be transposed while in a compressed sparse format. The transpose of the sparse weight data and index can be transposed as described above.

740, activation gradients for the previous layer can be computed by sparse matrix-matrix multiplication (spMM) of the transposed sparse weight data for the current layer, the transposed sparse weight indices of the current layer and activation gradients for the current layer. Sparse matrix-matrix multiplication can be performed as described above. At 750, weight gradients for the current layer can be computed by sampled dense-dense matrix multiplication (SDDMM) of the activation for the previous layer, activation gradients for the current layer, and the indices of the sparse weight matrix for the current layer. Sampled dense-dense matrix multiplication can be performed as described above. At 770, the weight values of the sparse weight matrix for a next iteration can be computed from the current weight values of the sparse weight matrix and the weight gradient for the current layer. The method of neural network training 710-760 can be iteratively repeated for a plurality of input datasets until a desired accuracy is achieved.

Again, it should be appreciated that computing the activations in the forward pass at 710 is typically performed first for each of the plurality of layers of a neural network (NN) model. Computing the activation gradients and weight gradients in the reverse pass at 720-760 can then be performed for each of the plurality of layers of the neural network (NN) model for a training dataset.

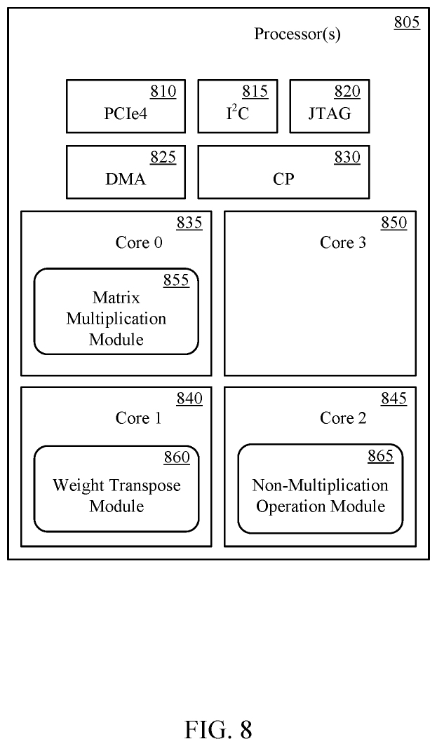

Referring now to FIG. 8, an exemplary processing unit including for implementing embodiments of a neural network (NN) model training, in accordance with aspects of the present technology, is shown. The processing unit 805 can include one or more communication interfaces, such as peripheral component interface (PCIe4) 810 and inter-integrated circuit (I²C) interface 815, an on-chip circuit tester, such as a joint test action group (JTAG) engine 820, a direct memory access engine 825, a command processor (CP) 830, and one or more cores 835-850. The one or more cores 835-850 can execute one or more sets of computing device executable instructions to perform the systems and methods of training a neural network model as described above. The one or more cores 835-850, for example can include one or more matrix multiplication modules 855, one or more weight transpose modules 860 and one or more non-multiplication operation modules 865. The one or more matrix multiplication modules 855 can be configured to compute activations, of the neural network (NN) model, in a forward pass by a sparse matrix-matrix multiplication (spMM) module using a sparse weight matrix that is transpose invariant, as described above. The one or more matrix multiplication modules 855 can also be configured to compute activation gradients, of the neural network (NN) model, in a backward pass by the sparse matrix-matrix multiplication (spMM) module using a transpose of the sparse weight matrix received from a weight transpose module, as described above. The one or more weight transpose modules 860 can be configured to compute transposes of the transposed invariant sparse weight matrix as described above. The one or more non-multiplication operation modules 865 can be configured to provide non-multiplication operation support to the one or more weight transpose modules 860. The one or more functions can be performed on individual core 835-850, can be distributed across a plurality of cores 835-850, can be performed along with one or more other functions on one or more cores, and or the like.

The processor unit 805 can be a central processing unit (CPU), a graphics processing unit (GPU), a neural processing unit (NPU), a vector processor, a memory processing unit, or the like, or combinations thereof. In one implementation, one or more processors 805 can be implemented in a computing devices such as, but not limited to, a cloud computing platform, an edge computing device, a server, a workstation, a personal computer (PCs), or the like.

For transpose invariant sparse weight matrix having a 50% sparsity, the training kernel runtime can be improved between 1.6 to 1.7 times as compared to training with a dense weight matrix. Furthermore, the end-to-end model runtime training for a bidirectional encoder representations for transformers (BERT) neural network model can be improved by about 1.3 times.

Neural networks (NN) models in accordance with aspects of the present technology enable computing devices to learn functions during training. Through practical application of various mathematical functions, neural network models can learn various relationships from datasets thereby improving the performance of computers as compared to conventional software routines. In contrast, conventional computing processes perform functions based on the knowledge encoded by programmers in the corresponding set of instructions prior to execution by the computing device. Neural network models instead enable the computing device to learn and encode the knowledge during training, and apply the learned knowledge during interference to perform corresponding functions. Therefore, the neural network models enable the computing device to improve its own operation to solve real world problems. Furthermore, aspects of the present technology reduce the neural network training time be leveraging transpose invariant sparsity, thereby further improving the performance of the computing device.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A method of training a neural network (NN) model comprising:
computing activations, of the neural network (NN) model, in a forward pass by a sparse matrix-matrix multiplication (spMM) module using a sparse weight matrix that is transpose invariant;
computing activation gradients, of the neural network (NN) model, in a backward pass by the sparse matrix-matrix multiplication (spMM) module using a transpose of the sparse weight matrix received from a weight transpose module; and
computing weight gradients, of the neural network (NN) model, in a backward pass by a sampled dense-dense matrix multiplication (SDDMM) module using the activations received from the forward pass of the sparse matrix-matrix multiplication (spMM) module.

2. The method according to claim 1, further comprising:
computing the activations for a current layer, by the sparse matrix-matrix multiplication (spMM) module, based on activations of a previous layer, sparse weight data of the sparse weight matrix of the current layer and sparse weight indices of the sparse weight matrix of the current layer in response to input datasets;
transposing the sparse weight indices of the current layer by the weight transpose module;
transposing the sparse weight data of the current layer by the weight transpose;
computing activation gradients for the previous layer, by the sparse matrix-matrix multiplication (spMM) module, based on the transposed sparse weight indices of the current layer, the transposed sparse weight data of the current layer, and activation gradients of the current layer;
computing weight gradients of the current layer, by the sampled dense-dense matrix multiplication (SDDMM) module, based on activations of the previous layer, the sparse weight indices of the current layer and the activation gradients of the current layer; and
computing sparse weight data of the current layer for a next iteration based on the weight gradients and the current sparse weight data.

3. The method according to claim 2, wherein:
the sparse weight data is transpose invariant; and
the sparse weight indices is transpose invariant.

4. The method according to claim 2, wherein the sparse matrix-matrix multiplication (spMM) module in the forward pass is reused utilizing the transpose invariant sparse weight matrix in the backward pass to compute the activation gradients.

5. The method according to claim 2, wherein the neural network (NN) model is trained with non-zero computations using the transpose invariant sparse weight matrix.

6. The method according to claim 2, wherein the transposed sparse weight data is transposed from the sparse weight data in a compressed format.

7. A system for neural network (NN) model training comprising:
a multiplication module including one or more sparse matrix-matrix multiplication (spMM) modules and one or more sampled dense-dense matrix multiplication (SDDMM) modules;
a weight data transpose module configured to transpose sparse weight data of a transpose invariant sparse weight matrix for a current layer;
a weight indices transpose module configured to transpose sparse weight indices of the sparse weight matrix for the current layer;
the one or more sparse matrix-matrix multiplication (spMM) modules configured to,
compute activations for a current layer based on the activations for a previous layer, the sparse weight data for the current layer, and the sparse weight indices for the current layer in forward propagation of a current cycle of batch datasets; and
compute activation gradients for the previous layer based on the transposed sparse weight data of the current layer, the transposed sparse weight indices of the current layer and activation gradients for the current layer in back propagation;
the one or more sampled dense-dense matrix multiplication (SDDMM) modules configured to compute weight gradients for the current layer based on the activation gradients for the current layer and the activations for the previous layer in the back propagation; and
a weight update module configured to compute new sparse weights based on the current weight gradients.

8. The system of claim 7, wherein:
the sparse weight data is transpose invariant; and
the sparse weight indices are transpose invariant.

9. The system of claim 7, wherein the one or more sparse matrix-matrix multiplication (spMM) modules used in the forward propagation is reused utilizing transpose invariant sparse weight matrix in the back propagation to compute the activation gradients of the current layer.

10. The system of claim 7, wherein the neural network (NN) is trained with non-zero computations using the sparse weight matrix.

11. The system of claim 7, wherein the weight data transpose module computes the transposed sparse weight data for the current layer from the sparse weight data in the current layer in a compressed format.

12. The system of claim 7, further comprising a memory configured to:
store the activations for the current layer for use as the activation for the previous layer for a next batch dataset;
store the activation gradients for the current layer for use as the activation gradients for the previous layer for the next batch dataset;
store the new sparse weight data for use as the sparse weight data for the current layer for the batch dataset; and
store the spare weight data for the current layer and the sparse weight indices for the current layer.

13. The system of claim 12, wherein utilization of the memory is reduced proportional to the non-zero value weight ratio of the sparse weight matrix as compared to training the neural network (NN) using a dense weight matrix.

14. One or more computing device readable media having instructions store thereon that when execute by one or more processing units perform a method comprising:
computing activations, of the neural network (NN) model, in a forward pass by a sparse matrix-matrix multiplication (spMM) module using a sparse weight matrix that is transpose invariant;
computing activation gradients, of the neural network (NN) model, in a backward pass by the sparse matrix-matrix multiplication (spMM) module using a transpose of the sparse weight matrix received from a weight transpose module; and
computing weight gradients, of the neural network (NN) model, in a backward pass by a sampled dense-dense matrix multiplication (SDDMM) module using the activations received from the forward pass of the sparse matrix-matrix multiplication (spMM) module.

15. The one or more computing device readable media having instructions stored thereon that when executed by the one or more processing units perform the method according to claim 14, further comprising:
computing the activations for a current layer, by the sparse matrix-matrix multiplication (spMM) module, based on activations of a previous layer, sparse weight data of the sparse weight matrix of the current layer and sparse weight indices of the sparse weight matrix of the current layer in response to input datasets;
transposing the sparse weight indices of the current layer by the weight transpose module;
transposing the sparse weight data of the current layer by the weight transpose;
computing activation gradients for the previous layer, by the sparse matrix-matrix multiplication (spMM) module, based on the transposed sparse weight indices of the current layer, the transposed sparse weight data of the current layer, and activation gradients of the current layer;
computing weight gradients of the current layer, by the sampled dense-dense matrix multiplication (SDDMM) module, based on activations of the previous layer, the sparse weight indices of the current layer and the activation gradients of the current layer; and
computing sparse weight data of the current layer for a next iteration based on the weight gradients and the current sparse weight data.

16. The one or more computing device readable media having instructions stored thereon that when executed by the one or more processing units perform the method according to claim 15, wherein:
the sparse weight data is transpose invariant; and
the sparse weight indices is transpose invariant.

17. The one or more computing device readable media having instructions stored thereon that when executed by the one or more processing units perform the method according to claim 15, wherein the sparse matrix-matrix multiplication (spMM) module in the forward pass is reused utilizing the transpose invariant sparse weight matrix in the backward pass to compute the activation gradients.

18. The one or more computing device readable media having instructions stored thereon that when executed by the one or more processing units perform the method according to claim 15, wherein the neural network (NN) model is trained with non-zero computations using the transpose invariant sparse weight matrix.

19. The one or more computing device readable media having instructions stored thereon that when executed by the one or more processing units perform the method according to claim 15, wherein the transposed sparse weight data is transposed from the sparse weight data in a compressed format.

20. The one or more computing device readable media having instructions stored thereon that when executed by the one or more processing units perform the method according to claim 15, wherein the sampled dense-dense matrix multiplication (SDDMM) module utilizes portions of the sparse matrix-matrix multiplication (spMM) module to compute sampled dense-dense matrix multiplication functions.
